(19) United States
(12) Patent Application Publication
(10) Pub. No.: US 2008/0058988 A1
(43) Pub. Date: Mar. 6, 2008

(54) ROBOTS WITH AUTONOMOUS BEHAVIOR

(76) Inventors: Caleb Chung, Boise, ID (US); John R. Sosoka, Eagle, ID (US)

Correspondence Address: IRELL & MANELLA LLP, 1800 AVENUE OF THE STARS, SUITE 900, LOS ANGELES, CA, 90067, US

(21) Appl. No.: 11/775,709

(22) Filed: Jul. 10, 2007

Related U.S. Application Data
(63) Continuation-in-part of application No. 11/036,517, filed on Jan. 13, 2005.
(60) Provisional application No. 60/806,908, filed on Jul. 10, 2006.

(51) Int. Cl. G05B 15/00

(52) U.S. Cl. 700/258; 901/46

(57) ABSTRACT

A robot may be made to operate in response to changes in an environment by determining a currently dominant drive state for the robot from a plurality of competing drive states, sensing a change the environment, selecting an appropriate behavior strategy in accordance with the currently dominant drive state from a database of behavior strategies for response by the robot to the sensed changed, selecting one or more robotic motions to be performed by the robot from a database of robotic motions in accordance with the selected strategy and causing the robot to perform the selected robotic motions.

### CROSS REFERENCE TO RELATED APPLICATIONS

This application is a continuation-in-part of U.S. patent application Ser. No. 11/036,517, filed Jan. 15, 2005, incorporated herein in its entirety by this reference and claims the benefit of the filing date of U.S. provisional Application Ser. No. 60/806,908 filed Jul. 10, 2006.

### BACKGROUND OF THE INVENTION

1. Field of the Invention

This invention relates to robotics and in particular to robot which use life like motions and behaviors.

2. Description of the Prior Art

Conventional robotic systems use algorithms created for motion control and various levels of artificial intelligence interconnected by complex communications systems to produce robot actions such as movement. Such robotic movements have little resemblance to the movements of live creatures. The term “robot-like movement” has in fact come to mean non-life like movements. Even so, the development of such algorithms are robot specific and require substantial investment in development time and costs for each robot platform. The required algorithms must direct actuation of individual robot actuators to achieve the desired motion, such as moving the legs and feet while walking without falling over or repetitively walking into a wall. For example, in order to prevent the robot from losing balance and falling over, the robot's feet may be required to perform motions which are inconsistent with the motions of the rest of the robot body. Algorithms may attempt to maintain a desired relationship between actuators, for example to have the arms of a humanoid swing appropriately while walking, but the resultant robotic actions are immediately recognizable as robotic because they are typically both predictable and not life-like. The complexities involved in coordinating motions of various robotic actuators has made it difficult or impossible to create robotic movement which is recognizably characteristic for a life form or for an individual of a particular life form.

What is needed is a new paradigm for the development of robotic systems which provides life-like characteristics of the robotic motion which may recognizably be characteristic to a particular life form and/or individual of that life form.

### SUMMARY OF THE INVENTION

A method of operating a robot in response to changes in an environment may include determining a currently dominant drive state for a robot from a plurality of competing drive states, sensing a change the environment, selecting an appropriate behavior strategy in accordance with the currently dominant drive state from a database of behavior strategies for response by the robot to the sensed changed, selecting one or more robotic motions to be performed by the robot from a database of robotic motions in accordance with the selected strategy and causing the robot to perform the selected robotic motions.

The method of operating the robot may also include selecting a different one of the plurality of competing drives states to be the currently dominant drive state in response to the sensed changed in the environment. Changes in the response of the robot to sensed changes in the environment may be made by altering the database of behavior strategies and/or the database of robotic motions. The database of robotic motions may be populated at least in part with a series of relative short duration robotic motions which may be combined to create the more complex robotic motions to be performed by the robot.

### BRIEF DESCRIPTION OF THE DRAWINGS

FIG. 1 is a stylistic overview of the main elements of robot system 10.

### DETAILED DESCRIPTION OF PREFERRED EMBODIMENT(S)

An improved technique for capturing motion files is disclosed in U.S. patent application Ser. No. 11/036,517, Method and System for Motion Capture Enhanced Animatronics, filed Jan. 13, 2005, and incorporated herein by reference, in which signals for causing life-like robot motions are captured from a system which may be constrained to perform in the same physical manner as the target robot. That is, the captured motion files are limited to motion files which recreate “legal” motions that can be performed by the target robot. For example, the center of gravity of the robot during such legal motions is constrained to stay within a volume permitting dynamically stable motions by the robot because the center of gravity of the robot is constrained within that volume by the system by which the motion files are created or captured.

At the heart of the new system are an easily expanded database of predetermined legal robot motions (e.g. motions that the robot can achieve without for example falling over) which may be automatically implemented by software which uses competing drive states to select combinations of pre-animated—and therefore predetermined—motions to perform recognizable behaviors in response to both internal and external inputs. The robotic operating software may be called a “state machine” in that the robot's response to an input may depend upon pre-existing states or conditions of the robot. A database of strategies and triggers may be used to determine the robot's responses to changes in the internal or external environment. One substantial advantage of this approach is that the databases of strategies and pre-animated motions may be easily updated and expanded. New motions, and new responses to inputs, may be added without requiring the costly rewriting of existing software.

As a result, the robotic platform may easily be changed, for example without substantial porting to another computing platform, while retaining the same software architecture and maintaining benefit of the earlier developed robot motions. Legal movements can be made life-like by structuring the robot actuators to correlate with the animation source while the movements are life-like and not predictable because they change as a function of the robot's drive states responses to an ever changing environment. For example, the robot may become sluggish and/or less responsible as it gets tired, i.e. needs battery recharging.

The database of pre-animated legal motions may contain animation “snippets”, i.e. small legal robot motions which may be combined and used either to drive a robot platform or to drive the related animations software developed to produce graphical animation of the robot platform. The animation software may also be used for video games including the robot character and the memories of the robot and robotic character may be automatically exchanged and updated.

The “snippets” may be developed from the legal motions of the life form and are directly translated to legal motion signals driving robotic or animated actuators so that the robot may be seen as not only life-like but may also show the personality of an individual being modeled by the robot.

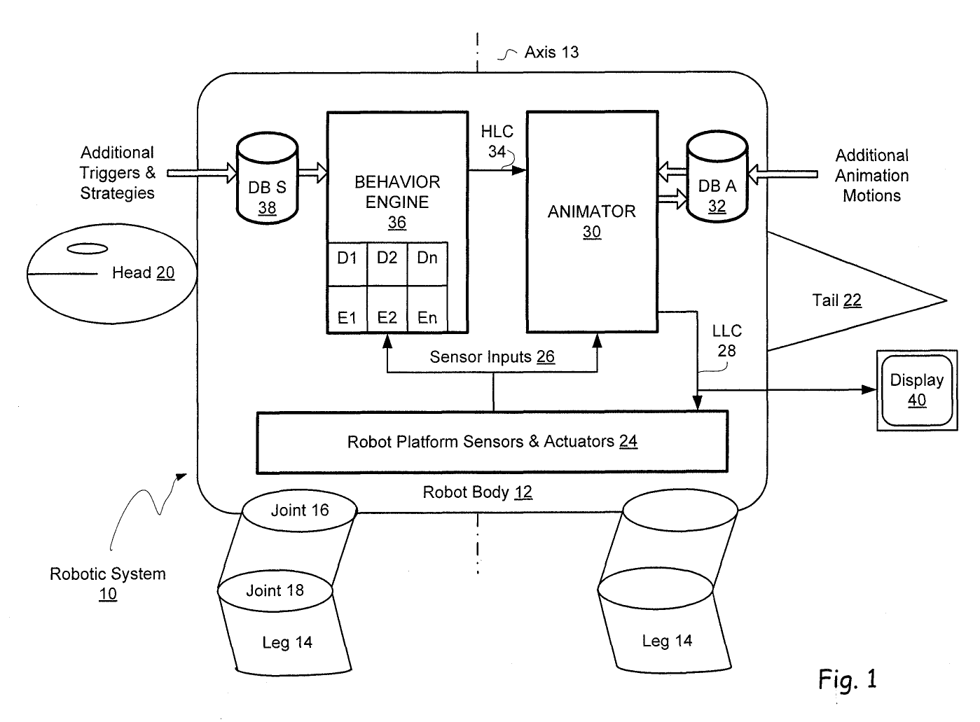

Referring now to FIG. 1, robotic system 10 may include robot body 12 articulated for motion around central axis 13 and supported by multiple legs 14 which may each include at least joints 16 and 18. Head 20 and tail 22 may also be articulated for motion with respect to body 12. Joints 16 and 18, as well as articulated motion about axis 13, are directly controlled by robot platform sensors and actuators 24 which also provide sensor inputs 26 from various internal, external and virtual sensors.

Platform 24 receives low level commands (LLC) 28 from animator 30 which directly controls robotic actuators such as the joints and articulation about axis 13. Animator 30 may stitch together a series of short duration animation sequences or “snippets” stored in animation database 32, and selected therefrom in response to high level commands (HLC) 34 from behavior engine 36. Animation snippets, or additional robotic motions, may be added to animation database 32 at any time from any source of legal motions, that is, motions derived from (and/or tested on) robot system 10 or its equivalent.

The animation snippets may represent generic motions or they may represent motions having particular personality characteristics. For example, if the snippets are derived from the motions of an actor, such as John Wayne, the resultant motion of the robot while walking may be recognizable as having the walk of John Wayne. The combination of the recognizable personality characteristics of a particular character and the ability of the robot to generate reasonable, but not merely repetitive, responses to a changing environment provide an amazingly life-like character. The fact that additional strategies for response to dominant drives, and additional snippets of motion for carrying out these strategies, may be easily added to databases without rewriting the installed software command base permit growing the depth of the robot character and therefore the ability for the robot to be a lifelike life form which grows and learns with time.

Behavior engine 36 generates HLC 34 in response to a) the currently dominant one of a series of drive status indicators, such as D1, D2 . . . which receive sensor inputs 26 indicating the internal, external and historical environment of robot 10, b) strategies stored in strategy data base 38 for responses in accordance with the dominant drive and c) sensor inputs that triggered or caused the dominance of a particular drive status. For example, based on sensory inputs that ambient light is present (i.e. it is daytime) and that a sufficiently long time has elapse since the robot 10 was fed (i.e. it is appropriate to be hungry), a drive status such as “Hunger” may be dominant among the drives monitored in behavior engine 36. One of the sensor inputs 26 related to the detection of the apparent presence or absence of a human (e.g. determined by the duration of time since the last time robot 10 was touched or handled) may be considered to be at least one of the triggers by which the Hunger drive became dominant.

Various related triggers and strategies may be stored for each drive in strategy database 38. For example, for the “Hunger” drive, the strategy “Search for Food Bowl” may be stored to correspond to the trigger that no human is present, while the strategy “Beg” may be stored to correspond to the trigger that a human is present. High Level Commands 34 corresponding to the strategy selected by the trigger may then applied by behavior engine 36 to animator 30. As a result, for example if a human is present, animator 30 may select appropriate animation snippets from animation database 32 to generate low level commands 28 which cause robot 10 to turn toward the human, make plaintive sounds and sit up in a begging posture.

In a preferred embodiment, a second set of drive states or emotion states E1, E2 . . . En may be provided which have a substantially different response time characteristic. For example, drive state D1 may represent Hunger which requires a substantial portion of a day to form while emotion state E1 may represent “Immediate Danger” which requires an immediate response. In this example, during implementation of a Food Bowl strategy caused by dominance of a Hunger drive triggered without the presence of a human, the Immediate Danger emotion state may be triggered by pattern recognition of a danger, such as a long, sinuous shape detected by an image sensor. The triggers for the Immediate Danger emotion state may include different distance approximations. If a trigger for Immediate Danger represented a short distance, the strategy to be employed for this trigger might include stopping all motion and/or reprocessing the image at a higher resolution or with a more detailed pattern recognition algorithm.

Robot 10 may be implemented from a lower layer forming a robot platform, such as robot platform sensors and actuators 24, caused to perform combinations of legal motion snippets derived from animation database 32 (developed in accordance with the teachings of U.S. application Ser. No. 11/036,517 described above) in accordance with a higher layer in the form of a state machine seeking homeostasis in light of one or more dominant drive states derived from combinations of internal, external and/or virtual sensors as described herein.

It is important to note that, just as with any other life form, the combination of internal, external and/or virtual sensor (i.e. derived from historical motions and responses) inputs, provides a wide variety of choices which can be reflected in the not merely repetitive nor arbitrary behavioral choices made by the creature in response to outside stimulation. Further, the responses are related to both the external world and the internal world of the character. As a result, the relationship between the robot and a child playing with the robot won't stagnate because the child will see patterns of the robot's behavioral responses rather than mere repetition of the same response to the same inputs. The relationship can grow because child will learn the patterns of the robot's response just as the child will learn the behaviors characteristic of other children.

Similarly, relationships with adults, and/or senior citizens, can be developed with age appropriate robotic platforms and behaviors, such as a cat or dog robot which interacts with a senior to provide companionship.

To enhance the experience for any type of robot 10, low level commands 28 may alternately be applied to suitable character animation software to display a characterization of robot 10 for animation on display 40, for example, as part of a video game. When animated in a video game, one or more of the sensors, behavior engine 36, animator 30 and strategy and animation databases 38 and 32 may drive their inputs, and/or be processed, in software. As a result, motions, strategies and the like for robot 10 may be tested with software on display 40 and vice versa.

Database of animation motions 32 and database of triggers and strategies 38 may be used in either a robotic platform or a video game or other display. Further, these databases may grow from learning experiences or other sources of enhancement. These databases may be exchanged, that is, behavior or experiences learned during operation of the databases in video game may be transferred to a robotic platform by transferring a copy of the database to from video game to become the corresponding database operated in a particular robotic platform.

1. A method of operating a robot in response to changes in an environment, comprising:
determining a currently dominant drive state for a robot from a plurality of competing drive states:
sensing a change the environment;
selecting an appropriate behavior strategy in accordance with the currently dominant drive state from a database of behavior strategies for response by the robot to the sensed changed;
selecting one or more robotic motions to be performed by the robot from a database of robotic motions in accordance with the selected strategy; and
causing the robot to perform the selected robotic motions.

2. The method of claim 1 further comprising:
selecting a different one of the plurality of competing drives states to be the currently dominant drive state in response to the sensed changed in the environment.

3. The method of claim 1 further comprising:
changing the response of the robot to sensed changes in the environment by altering the database of behavior strategies.

4. The method of claim 1 further comprising:
changing the response of the robot to sensed changes in the environment by altering the database of robotic motions.

5. The method of claim 1 further comprising:
populating the database of robotic motions at least in part with a series of relative short duration robotic motions; and
combining a plurality of the relatively short duration robotic motions to create the robotic motions to be performed by the robot.
